(19) United States
(12) Patent Application Publication
(10) Pub. No.: US 2010/0319168 A1
(43) Pub. Date: Dec. 23, 2010

(54) Clip for water

(75) Inventors: Chih-Hung Wu, Taoyuan County (TW); Wen-Biing Ou Yang, Taoyuan (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 12/081,388

(22) Filed: Apr. 15, 2008

(51) Int. Cl. F16B 2/26; F16B 2/20

(52) U.S. Cl. 24/457

(57) ABSTRACT

A clip includes a beam for contact with a face of a wafer, a first oblique section and a second oblique section for contact with an opposite face of the wafer. The beam includes a supporting section formed thereon. The first oblique section extends from the beam so that there is an acute angle between the first oblique section and the beam. The second oblique section extends from the first oblique section so that there is an acute angle between the first and second oblique sections and that there is an acute angle between a plane in which the supporting section lies.

### FIELD OF THE INVENTION

The present invention relates to a clip for a wafer and, more particularly, to a clip for increasing the friction between a wafer and a worktable on which the wafer is located.

### DESCRIPTION OF THE RELATED ART

A wafer requires after-production processing so that the wafer can exhibit desired properties. A wafer is a flat object with two smooth planar faces. The wafer is thin, light and fragile. The smooth planar faces could easily be scratched. During the after-production processing, it is inappropriate to hold the wafer with a clamp because the wafer could easily be damaged by the clamp that is often too powerful to handle a delicate object such as the wafer. Since precision is expected from the wafer, any fractures, slits or contamination could seriously jeopardize the properties of the wafer. Therefore, the wafer is often located on a worktable during the after-production processing. For including the smooth faces, the friction between the wafer and the worktable is small and the wafer tends to slide on the worktable, thus rendering it difficult to process the wafer. The properties of the wafer could easily be jeopardized. Therefore, the throughput of the production of such wafers is low.

The present invention is therefore intended to obviate or at least alleviate the problems encountered in prior art.

### SUMMARY OF THE INVENTION

It is the primary objective of the present invention to provide a clip for increasing the friction between a wafer and a worktable.

According to the present invention, a clip includes a beam for contact with a face of a wafer, a first oblique section and a second oblique section for contact with an opposite face of the wafer. The beam includes a supporting section formed thereon. The first oblique section extends from the beam so that there is an acute angle between the first oblique section and the beam. The second oblique section extends from the first oblique section so that there is an acute angle between the first and second oblique sections and that there is an acute angle between a plane in which the supporting section lies.

Other objectives, advantages and features of the present invention will become apparent from the following description referring to the attached drawings.

### BRIEF DESCRIPTION OF THE DRAWINGS

The present invention will be described via the detailed illustration of the preferred embodiment referring to the drawings.

FIG. 1 is a top view of a clip for a wafer according to the first embodiment of the present invention;

FIG. 2 is a side view of the clip shown in FIG. 1.

FIG. 3 is a top view of a wafer clipped with three clips such as the one shown in FIG. 1.

FIG. 4 is a top view of a clip according to the second embodiment of the present invention.

FIG. 5 is a side view of the clip shown in FIG. 4.

FIG. 6 is a top view of a clip according to the third embodiment of the present invention.

### DESCRIPTION OF THE PREFERRED EMBODIMENT

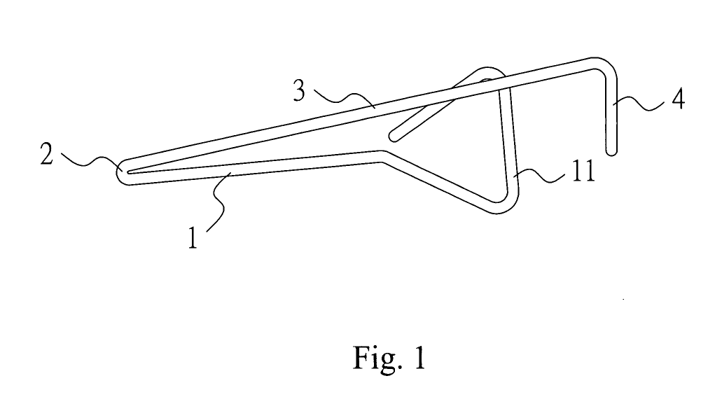

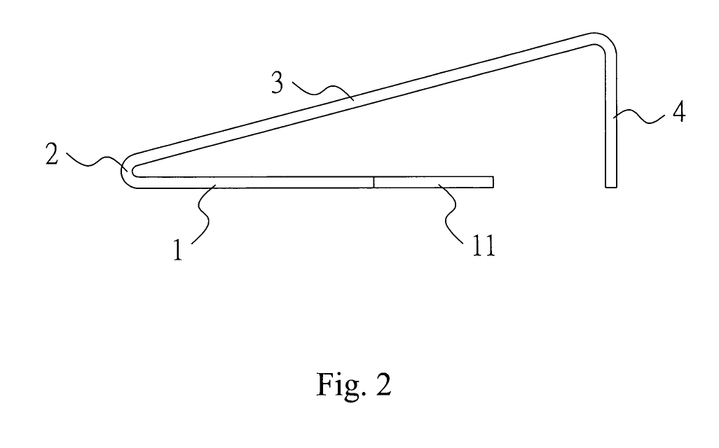

Referring to FIGS. 1 and 2, a clip include a beam 1, a connective section 2, a first oblique section 3 and a second oblique section 4 according to a first embodiment of the present invention. The clip is made by bending a metal rod so that is elastic.

The beam 1 includes a supporting section 11. The supporting section is in the form of a triangle in the first embodiment. However, the supporting section 11 may be in any other proper shape such as a circle, a square and any other polygons in another embodiment.

The connective section 2 is provided between the beam 1 and the first oblique section 3. The connective section 2 is a bent section.

There is an acute angle between the first oblique section 3 and a plane in which the supporting section 11 lies.

The second oblique section 4 extends from the first oblique section 3. There is an acute angle between the second oblique section 4 and the first oblique section 3. There is an acute angle between the second oblique section 4 and the plane in which the supporting section 11 lies.

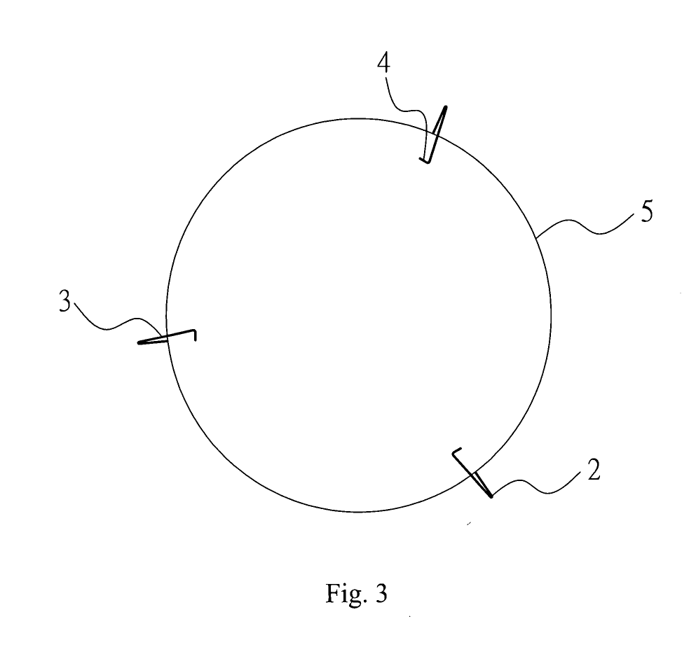

Referring to FIG. 3, a wafer 5 is clipped with three clips such as the one shown in FIGS. 1 and 2. The wafer 5 is located between the beam 1 and the second oblique section 4 of each of the clips. A lower face of the wafer 5 is located on the beam 1 and, more particularly, the supporting section 11. An upper face of the wafer 5 is pressed with the second oblique section 4. The wafer 5 is firmly clipped with the clips since each of the clips is made by bending a metal rod. When the wafer 5 and the clips are located on a worktable, the worktable is in contact with the beams instead of the wafer 5. The friction between the worktable and the beams 1 is adequate to keep the wafer still on the worktable. The friction between the worktable and the beams is larger as more clips are used. The friction between the worktable and the beams 1 is larger than the friction between the worktable and the wafer 5.

During after-production processing, it is easy to keep the wafer 5 still on the worktable because of the use of the clips. Therefore, it is easy to process the wafer 5. The properties of the wafer 5 could be controlled so that the throughput of the production of such wafers is high.

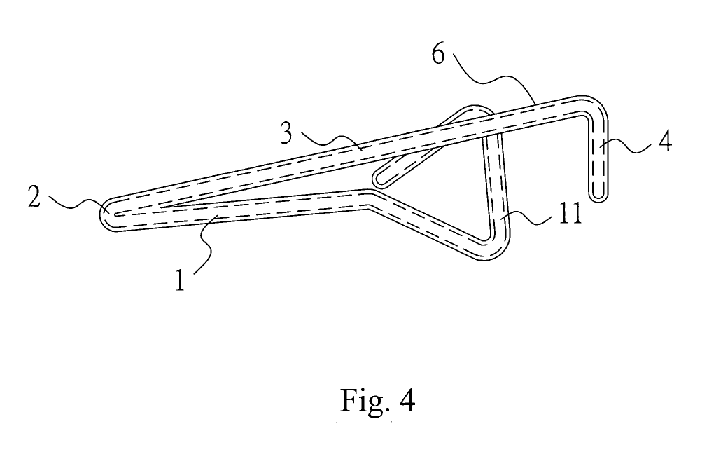

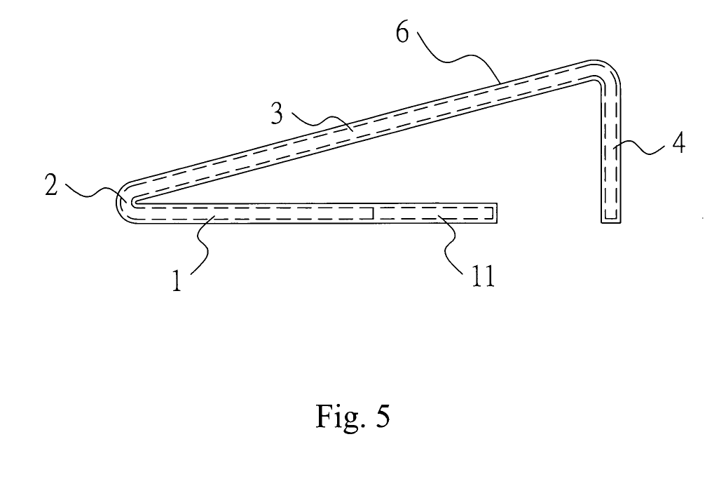

Referring to FIGS. 4 and 5, there is shown a clip according to a second embodiment of the present invention. The second embodiment is like the first embodiment excepting including a sheath 6 for wrapping the beam 1, the connective section 2, the first oblique section 3 and the second oblique section 4. The sheath 6 may be made of hard or soft plastics. The sheath prevents the clip from scratching the wafer 5 and prevents static charge from interfering with the wafer 5.

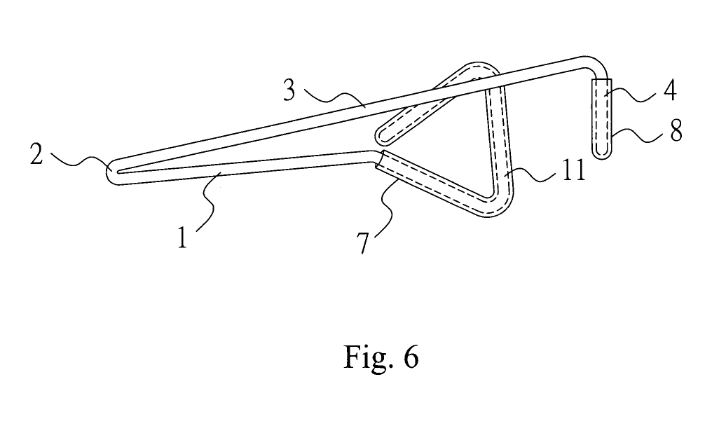

Referring to FIG. 6, there is shown a clip according to a third embodiment of the present invention. The third embodiment is like the first embodiment excepting including a sheath 7 for wrapping the supporting section 11 and a sheath 8 for wrapping the second oblique section 4.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A clip comprising:
a beam comprising a supporting section formed thereon for contact with a face of a wafer;
a first oblique section extending from the beam so that there is an acute angle between the first oblique section and the beam; and
a second oblique section for contact with an opposite face of the wafer, wherein the second oblique section extends from the first oblique section so that there is an acute angle between the first and second oblique sections and that there is an acute angle between a plane in which the supporting section lies.

2. The clip according to claim 1, wherein the beam and the first and second oblique sections are different sections of a same metal rod.

3. The clip according to claim 1 comprising a sheath for wrapping the beam and the first and second oblique sections.

4. The clip according to claim 3, wherein the sheath is made of hard plastics.

5. The clip according to claim 3, wherein the sheath is made of soft plastics.

6. The clip according to claim 1 comprising a sheath for wrapping the supporting section.

7. The clip according to claim 6, wherein the sheath is made of hard plastics.

8. The clip according to claim 6, wherein the sheath is made of soft plastics.

9. The clip according to claim 1 comprising a sheath for wrapping the second oblique section.

10. The clip according to claim 9, wherein the sheath is made of hard plastics.

11. The clip according to claim 9, wherein the sheath is made of soft plastics.
